(19) United States
(12) Patent Application Publication
(10) Pub. No.: US 2025/0321847 A1
(43) Pub. Date: Oct. 16, 2025

(54) PROACTIVE HOSTING CAPACITY ANALYSIS AND EVALUATION FOR DYNAMIC CONTAINER MIGRATION

(71) Applicant: Red Hat, Inc., Raleigh, NC (US)

(72) Inventor: Eder Ferreira Zulian, Grasbrunn (DE)

(21) Appl. No.: 18/633,204

(22) Filed: Apr. 11, 2024

(51) Int. Cl. G06F 11/34

(52) U.S. Cl. CPC G06F 11/3409

(57) ABSTRACT

A system and method of a proactive hosting capacity analysis and evaluation for dynamic container migration. The method includes receiving a request to analyze a performance of a containerized application executing on a host machine. The containerized application using one or more resources of the host machine to provide a quality of service. The method includes acquiring performance data associated with the containerized application by applying one or more stresses to the one or more resources. The method includes determining, based on the performance data, a likelihood for a degradation in the quality of service occurring prior to a satisfaction of one or more rules associated with a remedial action. The method includes performing, by a processing device prior to the satisfaction of the one or more rules, the remedial action to prevent the degradation in the quality of service.

### TECHNICAL FIELD

The present disclosure relates generally to software technology, and more particularly, to systems and methods of proactive hosting capacity analysis and evaluation for dynamic container migration.

### BACKGROUND

Containerization is the packaging together of software code with all its necessary components like libraries, frameworks, and other dependencies so that they are isolated in their own container. This is so that the software or application within the container can be moved and run consistently in any environment and on any infrastructure, independent of that environment or infrastructure's operating system. The container acts as a kind of bubble or a computing environment surrounding the application and keeping it independent of its surroundings. It is basically a fully functional and portable computing environment.

### BRIEF DESCRIPTION OF THE DRAWINGS

The described embodiments and the advantages thereof may best be understood by reference to the following description taken in conjunction with the accompanying drawings. These drawings in no way limit any changes in form and detail that may be made to the described embodiments by one skilled in the art without departing from the spirit and scope of the described embodiments.

FIG. 1 is a block diagram depicting an example environment for proactive hosting capacity analysis and evaluation for dynamic container migration, according to some embodiments;

FIG. 2A is a block diagram depicting an example of the host machine 102 of the environment in FIG. 1, according to some embodiments;

FIG. 2B is a block diagram depicting an example environment for using a host machine including a host capacity monitoring (HCM) system, according to some embodiments;

FIG. 3 is a flow diagram depicting a method of proactive hosting capacity analysis and evaluation for dynamic container migration, according to some embodiments; and

FIG. 4 is a block diagram of an example computing device that may perform one or more of the operations described herein, in accordance with some embodiments.

### DETAILED DESCRIPTION

Software applications (“applications”) can present different execution requirements such as deterministic latency behavior, achievable throughput, availability of specific hardware resources, and certain host configurations (e.g., tuning). The capacity of a host machine to satisfy all requisites imposed by all applications changes over time due to several reasons. For example, overall load of a host machine, operating environment (computing environment) of the host machine, a set of applications contending on specific resource without overloading other parts of the host machine, changes in the host machine configuration (e.g., tuning or misconfiguration), and/or the like. The conventional solutions to handle these changes are oriented to conditional “if-then” scenarios. That is, when the capacity of the host machine is exceeded, then events/alarms are generated and used to trigger the migration of applications from container-to-container running on the same host machine or on different host machines.

However, when a migration procedure of containerized applications takes place in the conventional system as a reaction to these events/alarm, then there is a window of time in which applications will operate sub-optimally or possibly fail to achieve the desired outcome, such as providing a service to one or more client devices. There is also the possibility that a partial or complete failure of the host machine may prevent the system from being able to perform the migration procedure to remedy the failure. Consequently, this may cause the host machines to inefficiently use their computing resources (e.g., memory, processing, etc.) and/or networking resources when executing containerized applications. Thus, there is a long felt need to solve the problems related to determining the optimal time to perform and/or prevent migration of containerized applications to optimize the performance of the applications, as well as the computing resources that the applications use when providing a service to client devices.

Aspects of the present disclosure address the above-noted and other deficiencies by providing a mechanism for proactive hosting capacity analysis and evaluation to determine the optimal time to perform and/or prevent migration of containerized applications. As discussed in greater detail below, the present disclosure describes a host capacity monitoring (HCM) system that deploys and/or instantiates a group of probes onto host machines that reside in one or more computing environments. Each of the probes are uniquely configured to introduce varying amounts of stress onto a particular computing resource (e.g., memory, processor, data storage, network, etc.) of the host machine that is executing the probe. The HCM system assesses the capacity and/or performance of a host machine by performing a series of experiments that use the probes of the host machine to gradually increase the amount of stress on one or more resources (e.g., memory, computing, storage, networking, etc.) of the host machine. The HCM system also uses the probes to collect the experimental data, which indicates the performance of the one or more resources of the host machine at each of the stress levels. The HCM system uses the experimental data to decide whether to perform an early migration of a containerized application from the host machine to another host machine and/or prevent incoming migrations from the other host machine. A migration of a container may be considered “early” if the migration takes place prior to a timing indicated by static rules (e.g., predetermined/pre-defined rules) associated with the host machine and/or computing environment of the host machine.

That is, the probes proactively probe a host machine to assess its capacity to sustain optimal execution conditions for containerized applications. This is based on a host monitor (referred to herein as a host machine monitor agent) that uses different probes to continuously perform the proactive runtime analysis and evaluation of host capabilities. This allows the HCM system to explore “what-if” scenarios in a gradual and controlled manner. This allows the HCM system to anticipate relevant bottlenecks that could reduce the outcome of applications running on the host machine. It also allows for automatic dynamic migration of applications, for example, but not limited to, in situations where certain thresholds are reached. The triggering conditions for migrations could, as non-limiting examples, be statically-defined by the user, or user-defined assisted by Artificial Intelligence (AI) and Machine Learning (ML) techniques, or based on AI and ML recommendation, etc.

The host monitor may profit from AI and ML techniques to learn and calibrate themselves. For example, the host monitor can learn how to adjust the intensity (e.g., stress level) of the probes, about the effects of adding multiple simultaneous probes, about the optimal execution time of a given probe, when to remove probes, and/or the like from previous probe deployments on the same host machine and/or from probe deployments made by the host monitor on different host machines.

The host monitor may receive and process probing requests. The host monitor may centralize one or more (or all) probing requests generated on their host machines. The host monitor may be configured to include decision making capabilities regarding when to deploy and how to configure (e.g., instantiate) the probes. The host monitor can terminate probes at any time to protect applications. For example, the host monitor may terminate a probe responsive to determining that a resource utilization threshold configured by a user or learned from previous probing is achieved. The host monitor may collect (e.g., retrieve or receive) data points from the execution of probes from one or more host machines. The host monitor may analyze multiple data points and provide metrics. The centralization of probing requests in the host monitor allows the HCM system to optimize the deployment of probes by reusing existing data points, filtering out unnecessary probe deployments, and/or the like.

The probes may provide various selectable stress levels allowing for gradual and controlled increase in load intensity on the resources of the host machines. The probes gather the experimental data from the resources and forward the experimental data to the host monitor. The host monitor (or by other specialized software module on behalf of the monitor) can terminate the probes at any time. The ability to fine-tune probes allows the HCM system to evaluate the capacity of the host machines without degrading application performance.

Each of the containerized applications are associated with one or more probes. The requirements presented by an application may be used as the basis for determining which probes are relevant for that application. Moreover, information to refine the association of applications with probes could be extracted, for example, from runtime analysis/profiling of applications. The applications, or a specialized software module (e.g., a probe request agent) that is working on behalf of the applications, can generate probing requests and send them to the host monitor, where the probing request indicates the identification of the application and the one or more probes associated with the application.

The HCM system performs a repeated (e.g., periodic and/or sporadic) runtime analysis to take in consideration different types of conditions (e.g., environment, toad of the host, configuration changes, etc.). The HCM system can store relevant data for every run in a data store (e.g., database, memory, flat file, etc.). The HCM system can use the relevant data to train AI and ML based models. The proactive runtime analysis of the host capacity can be used to anticipate the formation of relevant bottlenecks on a host machine. The analysis can also be used to early identify the impact of configuration changes on the host machine. The runtime evaluation can be used to automate the migration of containerized applications or applications to more suitable host machines that have the capacity to run the applications. Moreover, proactive hosting capacity analysis can be used to advertise that a host machine is able to accept incoming migrations. It can also be used to automatically refuse incoming migrations or to generate alarms/warnings and request approval from the user. Automatic dynamic migrations may happen before the formation of bottlenecks and/or malfunction of the host machine. The time applications operate under optimal conditions would be increased. Thus, key benefits of the embodiments of the present disclosure include an increase in the service availability of applications and the efficiency (e.g., latency and/or power) of the host machines executing the applications.

In an illustrative embodiment, a host monitor of the HCM system receives a request to analyze a performance of a containerized application executing on a host machine. The containerized application uses one or more resources of the host machine to provide a quality of service. The HCM system acquires performance data associated with the containerized application by applying one or more stresses to the one or more resources. The HCM system determines, based on the performance data, a likelihood for a degradation in the quality of service occurring prior to a satisfaction of one or more rules associated with a remedial action. The HCM system performs, prior to the satisfaction of the one or more rules, the remedial action to prevent the degradation in the quality of service.

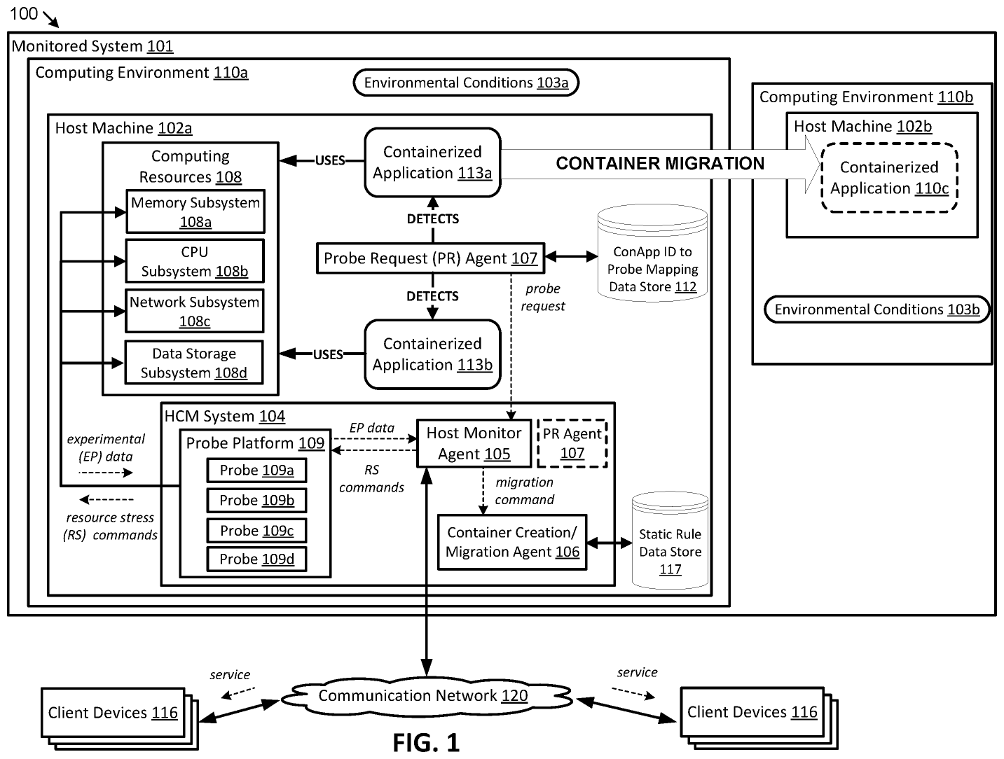

FIG. 1 is a block diagram depicting an example environment for proactive hosting capacity analysis and evaluation for dynamic container migration, according to some embodiments. Environment 100 includes a monitored system 101 and client devices 116 that are each communicably coupled together via a communication network 120. The monitored system 101 includes computing environments 110 (e.g., computing environments 110a, 110a) and a host machines 102 (e.g., host machines 102a, 102b). Specifically, computing environment 110a includes host machine 102a and computing environment 110b includes host machine 102b.

The host machine 102a includes computing resources 108, a host capacity management (HCM) system 104, a probe request (PR) agent 107, containerized applications 113 (e.g., containerized application 113a, containerized application 113b), a containerized application identifier (ID) to probe mapping data store 112, and a static rule data store 117. The computing resources 108 include a memory subsystem 108a, a central processing unit (CPU) subsystem 108b, a network subsystem 108c, and a data storage subsystem 108d. In some embodiments, the HCM system 104 may execute on a computing device (e.g., another host machine or non-host machine, such as a Remote Administration/Management system) that is separate from the host machine 102a.

Each containerized application 113 uses (e.g., demands) a unique amount of the computing resources 108 to be able to provide a service to the one or more client device 116. For example, containerized application 113a may demand 50 megabytes (MB) of memory from the memory subsystem 108a, two processing threads from the CPU subsystem 108b, 0 megabits per second (Mbps) of networking bandwidth from the network subsystem 108c, and 250 MB of storage space from the data storage subsystem 108d to be able to provide a first service to client devices 116. Conversely, containerized application 113b may demand 20 MB of memory from the memory subsystem 108a, one processing thread from the CPU subsystem 108b, 100 Mbps of networking bandwidth from the network subsystem 108c, and 350 MB of storage space from the data storage subsystem 108d to be able to provide a second service to client devices 116. In some embodiments, the amount of resources demanded by an application varies/fluctuates over time.

The HCM system 104 includes a probe platform 109, a host monitor agent 105, a container creation/migration (CCM) agent 106, and optionally, the probe request agent 107.

The probe platform 109 includes a probe 109a that is operatively coupled to the memory subsystem 108a, a probe 109b that is operatively coupled to the CPU subsystem 108b, a probe 109c that is operatively coupled to the network subsystem 108c, and a probe 109d that is operatively coupled to the data storage subsystem 108d. Each probe 109 is configured to receive a resource stress command from the host monitor agent 105, where the resource stress command indicates a particular amount of stress (e.g., consume resource) to apply onto the subsystem that is operatively coupled to the probe 109.

For example, the host monitor agent 105 may send, to the probe 109a, a first resource command indicating a first level of stress (either a decrease or increase) to be applied onto the memory subsystem 108a, and in response, the probe 109a may send the first resource command to the memory subsystem 108a to cause the first level of stress to be applied onto the memory subsystem 108a. The host monitor agent 105 may send, to the probe 109b, a second resource command indicating a second level of stress to be applied onto the CPU subsystem 108b, and in response, the probe 109b may send the second resource command to the CPU subsystem 108b to cause the second level of stress to be applied onto the CPU subsystem 108b. The host monitor agent 105 may send, to the probe 109c, a third resource command indicating a third level of stress to be applied onto the network subsystem 108c, and in response, the probe 109c may send the third resource command to the network subsystem 108c to cause the third level of stress to be applied onto the network subsystem 108c. The host monitor agent 105 may send, to the probe 109d, a fourth resource command indicating a fourth level of stress to be applied onto the data storage subsystem 108d, and in response, the probe 109d may send the fourth resource command to the data storage subsystem 108d to cause the fourth level of stress to be applied onto the data storage subsystem 108d.

Each of the probes 109 are further configured to monitor their respective subsystem and generate and/or collect experimental data indicating the performance of the subsystem when being subjected to the applied stress. Each probe then sends the experimental data back to the host monitor agent 105 for processing.

The containerized application identifier (ID) to probe mapping data store 112 includes mapping data that indicates a mapping between an ID of a containerized application 113 and a particular set of probes 109. That is, each containerized application 113 is associated with a particular set of the probes 109 corresponding to the types of computing resources 108 the containerized application 113 demands when running. For example, the containerized application 113a may demand 50 megabytes (MB) of memory from the memory subsystem 108a, two processing threads from the CPU subsystem 108b, 0 megabits per second (Mbps) of networking bandwidth from the network subsystem 108c, and 250 MB of storage space from the data storage subsystem 108d to be able to provide a first service to client devices 116. In this example, the containerized application identifier (ID) to probe mapping data store 112 includes a first set of mapping data indicating an association between the ID of the containerized application 113a and probe 109a, probe 109b, and probe 109d. The first set of mapping does not indicate an association with probe 109c because the containerized application 113a does not used any of the resources of the network subsystem 108c to provide the first service to the client devices 116.

Conversely, the containerized application 113b may demand 20 MB of memory from the memory subsystem 108a, one processing thread from the CPU subsystem 108b, 100 Mbps of networking bandwidth from the network subsystem 108c, and 350 MB of storage space from the data storage subsystem 108d to be able to provide a second service to client devices 116. In this example, the containerized application identifier (ID) to probe mapping data store 112 includes a second set of mapping data indicating an association between the ID of the containerized application 113b and probe 109a, probe 109b, probe 109c, and probe 109d. Notably, the second set of mapping does indicate an association with probe 109c because the containerized application 113b does use the resources of the network subsystem 108c to provide the second service to the client devices 116

The CCM agent 106 is configured to perform a container migration procedure according to the static rules stored in the static rule data store 117. The static rules may indicate that the CCM agent 106 should migrate a containerized application 113 from the host machine 102a to host machine 102b if the performance of the containerized application 113 fails to satisfy a predetermine performance level (e.g., a static value). For example, the CCM agent 106 may migrate the containerized application 113a from the host machine 102a to the host machine 102b if the CM agent determines that the latency of the containerized application 113a causes the performance of the containerized application 113a to drop below a static/minimum performance as indicated by the static rules. The CCM agent 106 is configured to containerize applications 113 and cause the containerize applications 113 to be executed on the host machine 102. In some embodiments, the static rules are not changed after the probe request agent 117 receives the probe request and before (or at the time of) the host monitor agent 105 determines a likelihood for a degradation in the quality of service occurring prior to a satisfaction of the static rules associated with a remedial action.

The probe request agent 107 may be configured to detect that a containerized application 113 is executing on the host machine 102, and in response retrieve the mapping data from the containerized application ID to probe mapping data store 112 that is associated with the containerized application 113 and generate a probe request that includes the mapping data. The probe request agent 107 sends the probe request to the host monitor agent 105, where the probe request is a request for the host monitor agent 105 to begin performing runtime experiments involving the containerized application 113 that is associated with the mapping data in the probe request.

Upon receiving the probe request, the host monitor agent 105 deploys and/or instantiates (e.g., starts, brings-up, initializes, activates) the particular probes that are indicated in the mapping data of the probe request onto the host machine 102a, so to begin monitoring the computing resources 108 that are used by the containerized applications 113.

The host monitor agent 105 performs a series of experiments to test whether the static rules are indicative of the optimal time for the CCM agent 106 to perform a container migration procedure, so to prevent a client device 116 from experiencing degraded service from the containerized application 113. Specifically, the host monitor agent 105 performs the series of experiments to determine if there are a particular set of environmental conditions and/or configurations of the host machine 102 and/or containerized applications 113 that could degrade the performance of the host machine 102a and/or the containerized applications 113, but where the CCM agent 106 would not have been able to detect this degradation if the CCM agent 106 was basing its determination of the timing to perform a container migration on the only static rules. Thus, the host monitor agent 105 might discover, when analyzing the experimental data that it collects from the series of experiments, that host monitor agent 105 should perform a remedial action ever though the static rules have not yet been satisfied.

The host monitor agent 105 performs the series of experiments by sending a series of resource stress command to the probe platform 109. For example, the host monitor agent 105 may determine that the mapping data in the probe request indicates that probe 109a and probe 109b are associated with containerized application 113a. In response, the host monitor agent 105 generates a first group of resource stress commands for probe 109a and a second group of resource stress commands for probe 109b. Each resource stress command of the first group of resource stress commands corresponds to a unique stress level for the memory subsystem 108a, and each resource stress command of the second group of resource stress commands corresponds to a unique stress level for the CPU subsystem 108b. The host monitor agent 105 sends the first group of resource stress commands to probe 109a, which causes the probe 109a to send the first group of resource stress commands to the memory subsystem, which in turn, gradually increases or decreases the stress on the memory subsystem 108a according to the stress level indicated in first group of resource stress commands. The host monitor agent 105 sends the second group of resource stress commands to probe 109b, which causes the probe 109b to send the second group of resource stress commands to the CPU subsystem 108b, which in turn, gradually increases or decreases the stress on the CPU subsystem 108b according to the stress level indicated in second group of resource stress commands.

As discussed here, the host monitor agent 105 of the HCM system 104 takes remedial actions based on the analysis and evaluation of the experimental data. These remedial actions include performing an early migration (e.g., earlier than indicated by the static rules), preventing (e.g., blocking) any incoming migrations, and/or providing a notification to an administrator of the monitored system 101 and/or client device 116 to indicate a likelihood for a degradation in the quality of service occurring prior to a satisfaction of one or more rules associated with a remedial action.

The communication network 120 may be a public network (e.g., the internet), a private network (e.g., a local area network (LAN) or wide area network (WAN)), or a combination thereof. In one embodiment, communication network 120 may include a wired or a wireless infrastructure, which may be provided by one or more wireless communications systems, such as wireless fidelity (Wi-Fi) connectivity to the communication network 120 and/or a wireless carrier system that can be implemented using various data processing equipment, communication towers (e.g., cell towers), etc. The communication network 120 may carry communications (e.g., data, message, packets, frames, etc.) between any other the computing device.

A container or containerized application 113 is a container image that is being executed on a processing device of the host machine 102. A container image is a standard unit of software that packages up code and one or more (e.g., or all) of its dependencies so that a software application may run efficiently and reliably from one computing environment to another. That is, a container image is a lightweight, standalone, executable package of software that includes everything (e.g., code, runtime, system tools, system libraries and settings) needed to run an application. The container image includes layers (e.g., image layers) that are stacked on top of one other. The flexibility of layers is that they can be interchanged, meaning that a user of the container can quickly swap functionality out as needed without impacting the overall container's purpose.

A layer may include application code, libraries, system tools, dependencies, configuration/setting files, environment variables, runtimes, and other files needed to make an application execute. A layer may be configured to provide a service. Non-limiting examples of a service include a database or repository service, a compute service, a file system service, a cloud storage service, an application service, a network service, a network traffic management service, a cybersecurity service, etc.

A container image that includes multiple layers may provide a variety of different types of services according to the layers, wherein each layer uses (e.g., allocates, reserves) a particular set of computing resources 108 and a particular amount of each computing resource 108 (e.g., computing/processing, data storage, memory) of the host machine 102a that executes the container image. For example, a first layer (e.g., layer 1) of a container image may be configured to provide a database service that uses 1 gigabyte (GB) of data storage and 100 megabytes (MB) of memory of the host machine 102a, and a second layer (e.g., layer 2) of the container image may be configured to provide a file system service that uses 0.5 gigabyte (GB) of data storage and 50 megabytes (MB) of memory of the computing environment, and a third layer (e.g., layer 3) of container image may be configured to provide a network service that uses 200 megabytes (MB) of memory and no amount of data storage of the host machine 102a.

In some embodiments, the layers of a container image may each use a different amount of computing resources 108 to provide an identical or substantially identical service. For example, a first layer (e.g., layer 1) of a container image may be configured to provide a database service and a second layer (e.g., layer 2) of the container image may also be configured to provide the same or substantially similar database service. However, the first layer may be configured to have a high priority status to cause the host machine 102a to allocate 25% of its compute (e.g., central processing unit (CPU)) resources to the first layer, and the second layer may be configured to have a low priority status to cause the host machine 102a to allocate 5% of its compute resources 108 to the second layer. As such, the database service provided by the first layer may operate faster, more accurately, and/or more efficiently than the database service provided by the second layer.

Each host machine 102 operates within a computing environment 110 that is associated with a particular set of environment conditions 103. Specifically, host machine 102a operates in computing environment 110a, which is associated with environment conditions 103a and host machine 102b operates in computing environment 110b, which is associated with environment conditions 103b. The environment conditions 103 indicate the operating conditions for the respective computing environment 110. These environment conditions 103 include, for example, temperature, pressure, relative humidity, current workload (e.g., due to currently running applications) on the host machine 102, contention for specific operating system resources, contention for hardware resources, conflicting configurations applied to the host machine 102, poorly defined set of conditions for migration at container-management level, electromagnetic interference that can cause unusual system behavior and/or hardware malfunction.

In some embodiments, the computing environment 110a and the computing environment 110b may each be located in different geographic locations; and therefore, have different environment conditions 103. For example, the host machine 102a may be located on a server rack located in California and a host machine 102b may be located on a server rack located in New York.

In some embodiments, the computing environment 110a and the computing environment 110b may both be located in the same geographic location, but still physically separated from one another, and therefore have different environment conditions 103. For example, computing environment 110a and computing environment 110b may both be located in the same data center, where the host machines 102a of computing environment 110a is positioned on a first rack in the data center and the host machines 102b of computing environment 110b is positioned on a second rack in the same data center. Each of the computing environments 110 may be associated with different environment conditions 103 because the first rack could be positioned in a first corner of the data center where there are no cooling units, and the second rack could be positioned in second corner of the data center where there are cooling units.

The set of environment conditions 103 associated with a computing environment may impact the performance of the host machines 102 operating in the computing environment. For example, the containerized application 113a may provide a database service that, when executing on host machine 102a, is configured to communicate to a remote storage via the network subsystem 108c of the host machine 102a. However, if the network subsystem 108c is experiencing excessive network congestion and/or network latency, then the containerized application 113a might not run/operate optimally, such as running at a slower speed than its full capability. As another example, the temperature of the one or more CPUs of the host machine 102 may rise to a level that causes excessive latency in the one or more CPUs, resulting in a reduction in clock/data frequencies, which in turn, degrades the ability for the containerized application 113 to provide an uninterrupted service to the client devices 116.

A host machine 102a and client device 116 may each be any suitable type of computing device or machine that has a processing device, for example, a server computer (e.g., an application server, a catalog server, a communications server, a computing server, a database server, a file server, a game server, a mail server, a media server, a proxy server, a virtual server, a web server), a desktop computer, a laptop computer, a tablet computer, a mobile device, a smartphone, a set-top box, a graphics processing unit (GPU), etc. In some examples, a computing device may include a single machine or may include multiple interconnected machines (e.g., multiple servers configured in a cluster).

A computing device may be one or more virtual environments. In one embodiment, a virtual environment may be a virtual machine (VM) that may execute on a hypervisor which executes on top of an operating system (OS) for a computing device. The hypervisor may manage system sources (including access to hardware devices, such as processing devices, memories, storage devices). The hypervisor may also emulate the hardware (or other physical resources) which may be used by the VMs to execute software/applications. In another embodiment, a virtual environment may be a container that may execute on a container engine which executes on top of the OS for a computing device. For example, a container engine may allow different containers to share the OS of a computing device (e.g., the OS kernel, binaries, libraries, etc.). A computing device may use the same type or different types of virtual environments. For example, all of the computing devices may be VMs. In another example, all of the computing devices may be containers. In a further example, some of the computing devices may be VMs, other computing device may be containers, and other computing devices may be computing devices (or groups of computing devices).

### Additional Implementations of the HCM System

As discussed herein, the HCM system 104 performs runtime experiments to identify how likely certain conditions are to be satisfied, and in response, perform an early container migration and/or prevent incoming migrations. The HCM system 104 may repeatedly perform these controlled experiments at any time, include at runtime and/or responsive to receiving a probe request from the probe request agent 107 and/or from a client device 116. Probes 109 are instantiated in the host machine 102a to gradually stress the computing resources 108. The HCM system 104 may configure the stress level applied by the probes 109 and/or the duration of the stress level.

The HCM system 104 may apply a margin of safety to every condition and threshold that is relevant to the experiment to prevent migrations from happening due to an experiment. This also avoids exceeding operating system thresholds that might be neglected by other conditions specified at container management level. The HCM system 104 can abort the experiments at any time and can abort the experiments quickly. The HCM system 104 may configure the experiments to be reproducible.

In some embodiments, the HCM system 104 may identify the experimental period by inserting special marks into system logs and by using different colors in visual representations of the data. In some embodiments, the HCM system 104 may disable the default migration mechanisms, alarm and event generation during experiments.

The HCM system 104 collects and stores experimental data for each experiment performed. For each host machine 102a and for each experiment performed, the HCM system 104 collects and stores the experimental data in a data store (e.g., memory, in a database, flat file).

The HCM system 104 analyzes the experimental data. Machine learning algorithms can be used, for example, to calculate the probability of threshold being exceeded when the computing resources 108 of the host machine 102a is under stress. The data can be used for training a model that predicts probabilities.

Relevant information derived from the experimental data may include, for example, metrics such as time spent in user-space during experiment, time spent in kernel space during experiment, cache misses, the percentage of CPU time waiting on I/O operations, number of page faults. Probability of a condition (or a set of conditions) to be satisfied. Probability of a threshold of interest to be exceeded under certain conditions (relevant parts of the system under pressure).

The host monitor agent 105 of the HCM system 104 takes actions based on the analysis and evaluation of the experimental data. These actions include performing an early migration (e.g., earlier than indicated by the static rules), and/or preventing (e.g., blocking) any incoming migrations.

Considering the actual operating conditions of the host machine 102 (e.g., actual load, actual connectivity, actual environmental conditions, etc.). Note that the actual operating conditions may differ from ideal operating conditions. In order to operate optimally (thus increasing the change of providing applications with optimal operating conditions), a host machine 102 might rely on supporting infrastructure. Infrastructure problems affecting devices external to the host machine 102, such as network equipment (e.g., gateways, routers, switches, etc.), heating, ventilation and air conditioning (HVAC) system, etc. might hinder the ability of a host system 102 to sustain optimal execution conditions for all the applications running on it. Higher temperatures may lead to a higher self-refresh rate in DRAM-based (dynamic random access memory) memory modules; thereby causing the hardware to automatically adjust the refresh rate (e.g., an adjustment in performance) to the temperature.

In a battery powered system, for example, the HCM system 104 may scale down the frequencies of CPU cores to conserve power. Temperature may also affect frequency scaling. In some embodiments, the host machine 102a may be subjected to electromagnetic interference (EMI), also called radio-frequency interference (RFI) generated by an external source (e.g., third-party radio equipment, atmospheric discharges, etc.), that can potentially hinder the ability of the host machine 102a to sustain optimal execution conditions for all the applications (e.g., containerized application 113) running on it. In some embodiments, inadvertent changes in the configuration of the network infrastructure may lead to network packets to be excessively delayed or dropped more often than usual. As a possible response to that the host system 102 may be reporting timeouts and resending more packets than usual. Thus, these are examples that illustrate how fluctuations of the computing environment 110 and changes in the infrastructure might affect the capacity of the host machine 102 and/or the ability of the host system 102 to sustain optimal execution conditions for all the applications running on it.

Even local configurations in the host machine 102 can be of advantage for some of the applications and of disadvantage for others. For example, the tuning of a host machine 102 for running real-time applications is usually necessary to allow real-time applications to respond to events within predictable and specific time constraints (e.g., low-latency between the event and its response). A host machine 102 tuning focused on low-latency behavior can have a negative impact on throughput-oriented applications which usually profit from large time slots of uninterrupted execution. The main reason is that real-time applications will often preempt others.

Similarly, it is hard to foresee indirect interactions between applications running in the same host. Even though a certain level of isolation is provided by containers (and other mechanisms) the underlying hardware is shared (or partially shared) by all applications. For example, buses and interconnects, main memory, storage devices, some operating system kernel interfaces and resources (e.g., syscall interface, timers, scheduler), etc. may be shared. Moreover, the load of a given application varies in time, hence the impact of that application in the overall system load varies.

For example, a given application serves a burst of requests (e.g., several requests arrive through the network very close to each other in time) generating a peak demand of shared resources (e.g., with possible increases in the number of interrupts, cache misses, kernel threads, active timers, files open, etc.), increasing its impact on the overall host machine load, and increasing the change of hindering other applications performance.

Some embodiments may gather multiple performance counter statistics and provide users with a comprehensive set of metrics, visualization tools, event monitoring and alerting. However, in other embodiments, even a comprehensive set of metrics may not be enough to fully capture the actual host capacity (e.g., to sustain optimal execution conditions to all applications running on it) under different operating conditions. This is due to the subtle direct and indirect interactions previously described that are very hard to identify.

The user (e.g., system administrator) is responsible to define one or multiple sets of conditions that, when satisfied, can generate alarms, events, and finally trigger actions such as the migration of an application to another host. The user may define the conditions by using tools, previously collected data, and by using knowledge about similar cases. The user may adjust the defined conditions based on a safety margin to account for the uncertainties and difficulties, as discussed herein. Independently from how the set of conditions to trigger migration was defined, the definitions remain unaltered until its next definition. When the set of conditions is satisfied, migration happens as a reaction.

There are risks related to migration as a reaction. For example, an incomplete or poorly-defined set of conditions might lead to a late attempt of migration; thereby causing the host machine 102 to quickly deteriorate. Migration may be prevented; thereby causing the service provided by the application to unavailable.

Even a set of conditions properly defined might fail to consider one or more of those subtle interactions that are difficult to foresee. For example, imagine a given host machine 102 operating normally. After a load rebalance, a new application is assigned to the host machine 102. In this example, the newly assigned application has a memory-intensive behavior. There is enough memory on the host machine 102 for all applications operating under normal conditions, hence the migration is allowed to happen. However, in this example, after the migration the memory-intensive application indirectly affects other applications in the host machine 102. The set of conditions is satisfied, and a new migration is triggered to evict an application from the host machine 102. This example illustrates a simplified situation in which applications operate sub-optimally and undesired migrations occur. The example considers only one aspect of the migrated application: its memory intensity. However, in a real scenario it is fair to expect that applications will affect each other indirectly in more complex and subtle ways that are hard to identify and to predict.

Thus, instead of focusing on determining an ideal set of conditions that takes into consideration every possible factor that could hinder the host machine's 102 capacity (of sustaining optimal execution conditions for all applications running on it), the HCM system 104 executes controlled experiments to estimate how likely it is that one or more conditions of a set will be satisfied under certain circumstances. The HCM system 104 aims to capture snapshots of the actual host machine's 102 capacity to sustain optimal conditions for applications running on it by repeatedly executing controlled experiments during runtime.

The experimental data collected is stored and analyzed to estimate how likely it is that one or more conditions of a set will be satisfied when relevant parts of the system are under different levels of stress.

The analysis of the experimental data is used to anticipate the formation of bottlenecks and other undesired situations. The HCM system 104 can reject and/or block an incoming migration if the HCM system 104 determines that the incoming application exhibits one or more characteristics in its resource utilization profile that have a high probability of causing bad indirect interactions that would negatively impact the applications already running on the host machine 102.

The HCM system 104 can anticipate the migration of applications. For example, several applications can be running on the host machine 102. Under normal conditions, all applications are performing as expected. However, the HCM system 104 may analyze the experimental data to determine that the experimental data indicates that there is a high probability that a threshold defined at operating system level will be exceeded (leading to overall performance degradation) when several processes are created in a short interval and both network and memory subsystems are under pressure. In this example, under normal conditions this situation rarely happens and the set of conditions for migration did not account for that operating system threshold. An early migration is performed based on the operating system threshold is performed even though not all migration conditions are satisfied.

The HCM system 104 can configure the experiments such that effects on the host system 102 and applications running on the host system 102 are transitory. In some embodiments, the HCM system 104 can prevent an experiment from causing a system failure, a system deterioration, and/or permanent degradation of system performance. Probes 109 can be implemented as containerized applications. Probes 109 can be implemented as regular (non-containerized) applications. Probes 109 can be implemented as a device driver. Probes 109 can be implemented as an operating system kernel utility. Probes 109 of different types can be deployed during an experiment. The presented embodiments may employ pre-defined sets of conditions at container management level.

Still referring to FIG. 1, the host monitor agent 105 of the HCM system 104 receives a request to analyze a performance of the containerized application 113a executing on the host machine 102a. The containerized application 113a uses one or more resources (e.g., computing resources 108) of the host machine 102a to provide a quality of service. The HCM system 104 acquires performance data associated with the containerized application by applying one or more stresses to the one or more resources. The HCM system 104 determines, based on the performance data, a likelihood for a degradation in the quality of service occurring prior to a satisfaction of one or more rules associated with a remedial action. The HCM system 104 performs, prior to the satisfaction of the one or more rules, the remedial action to prevent the degradation in the quality of service.

Although FIG. 1 shows only a select number of computing devices (e.g., host machines 102, HCM system 104, client devices 116), the environment 100 may include any number of computing devices that are interconnected in any arrangement to facilitate the exchange of data between the computing devices.

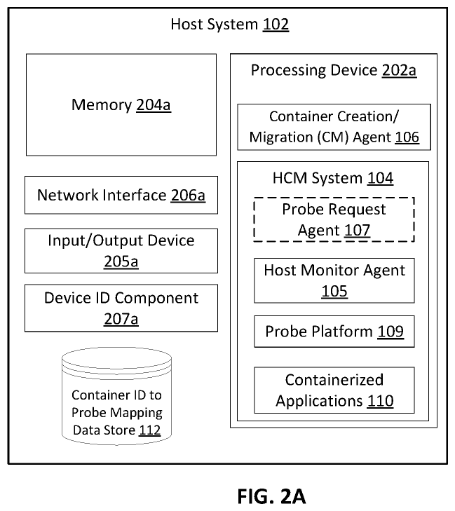

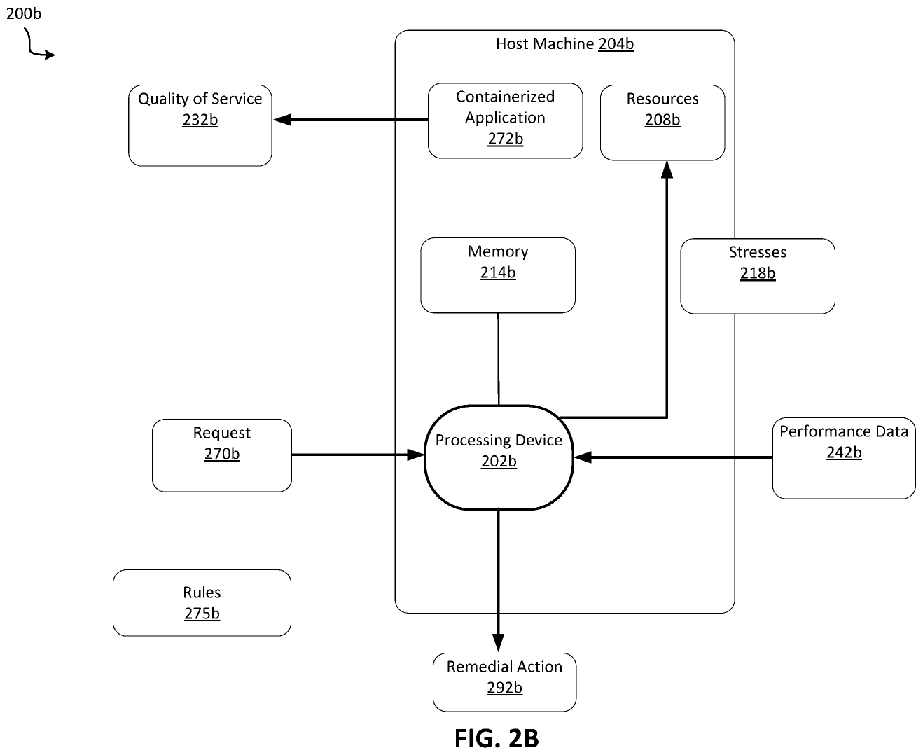

FIG. 2A is a block diagram depicting an example of the host machine 102 of the environment in FIG. 1, according to some embodiments. While various devices, interfaces, and logic with particular functionality are shown, it should be understood that the host machine 102 includes any number of devices and/or components, interfaces, and logic for facilitating the functions described herein. For example, the activities of multiple devices may be combined as a single device and implemented on the same processing device (e.g., processing device 202a), as additional devices and/or components with additional functionality are included.

The host machine 102 includes a processing device 202a (e.g., general purpose processor, a PLD, etc.), which may be composed of one or more processors, and a memory 204a (e.g., synchronous dynamic random-access memory (DRAM), read-only memory (ROM)), which may communicate with each other via a bus (not shown).

The processing device 202a may be provided by one or more general-purpose processing devices such as a microprocessor, central processing unit, or the like. In some embodiments, processing device 202a may include a complex instruction set computing (CISC) microprocessor, reduced instruction set computing (RISC) microprocessor, very long instruction word (VLIW) microprocessor, or a processor implementing other instruction sets or processors implementing a combination of instruction sets. In some embodiments, the processing device 202a may include one or more special-purpose processing devices such as an application specific integrated circuit (ASIC), a field programmable gate array (FPGA), a digital signal processor (DSP), network processor, or the like. The processing device 202a may be configured to execute the operations described herein, in accordance with one or more aspects of the present disclosure, for performing the operations and steps discussed herein.

The memory 204a (e.g., Random Access Memory (RAM), Read-Only Memory (ROM), Non-volatile RAM (NVRAM), Flash Memory, hard disk storage, optical media, etc.) of processing device 202a stores data and/or computer instructions/code for facilitating at least some of the various processes described herein. The memory 204a includes tangible, non-transient volatile memory, or non-volatile memory. The memory 204a stores programming logic (e.g., instructions/code) that, when executed by the processing device 202a, controls the operations of the host machine 102. In some embodiments, the processing device 202a and the memory 204 form various processing devices and/or circuits described with respect to the host machine 102. The instructions include code from any suitable computer programming language such as, but not limited to, C, C++, C #, Java, JavaScript, VBScript, Perl, HTML, XML, Python, TCL, and Basic.

The processing device 202 includes and/or executes an HCM system 104, a container creation/migration (CCM) agent 106, and a probe request agent 107. The HCM system 104 includes a host monitor agent 105, a probe request agent 107, a probe platform 109, and a containerized applications 113 (e.g., containerized application 113a, containerized application 113b). In some embodiments, the probe request agent 107 may reside outside of the HCM system 104.

The HCM system 104 may be configured to receive a request to analyze a performance of a containerized application executing on a host machine and/or one or more resources of the host machine that are being used by the containerized application. The containerized application uses the one or more resources of the host machine to provide a quality of service. The HCM system 104 may be configured to acquire performance data associated with the containerized application by applying one or more stresses to the one or more resources. The HCM system 104 may be configured to determine, based on the performance data, a likelihood for a degradation in the quality of service occurring prior to a satisfaction of one or more rules associated with a remedial action. The HCM system 104 may be configured to perform, prior to the satisfaction of the one or more rules, the remedial action to prevent the degradation in the quality of service.

In some embodiments, the request includes mapping data indicating one or more probes. The HCM system 104 may be configured to deploy the one or more probes onto the host machine to monitor the one or more resources. The HCM system 104 may be configured to apply the one or more stresses to the one or more resources further based on the one or more probes. In some embodiments, the performance data is indicative of at least one of a current demand on the one or more resources or a remaining capacity of the one or more resources.

The HCM system 104 may be configured to detect a change in the quality of service responsive to applying the one or more stresses to the one or more resources. The HCM system 104 may be configured to maintain, in a data store, a plurality of associations between a plurality of containerized application identifiers and a plurality of probe identifiers.

The HCM system 104 may be configured to perform the remedial action by causing a migration of the containerized application from the host machine to another host machine. The HCM system 104 may be configured to perform the remedial action preventing a migration of another containerized application from another host machine to the host machine.

The HCM system 104 may be configured to determine the likelihood for the degradation in the quality of service occurring prior to the satisfaction of the one or more rules associated with the remedial action is further based on environmental conditions associated with the host machine. The environmental conditions include one or more of temperature, electromagnetic interference, pressure, or humidity.

The host machine 102 includes a network interface 206a configured to establish a communication session with a computing device for sending and receiving data over a communication network to the computing device. Accordingly, the network interface 206a includes a cellular transceiver (supporting cellular standards), a local wireless network transceiver (supporting 802.11X, ZigBee, Bluetooth, Wi-Fi, or the like), a wired network interface, a combination thereof (e.g., both a cellular transceiver and a Bluetooth transceiver), and/or the like. In some embodiments, the host machine 102 includes a plurality of network interfaces 206a of different types, allowing for connections to a variety of networks, such as local area networks (public or private) or wide area networks including the Internet, via different sub-networks.

The host machine 102 includes an input/output device 205a configured to receive user input from and provide information to a user. In this regard, the input/output device 205a is structured to exchange data, communications, instructions, etc. with an input/output component of the host machine 102. Accordingly, input/output device 205a may be any electronic device that conveys data to a user by generating sensory information (e.g., a visualization on a display, one or more sounds, tactile feedback, etc.) and/or converts received sensory information from a user into electronic signals (e.g., a keyboard, a mouse, a pointing device, a touch screen display, a microphone, etc.). The one or more user interfaces may be internal to the housing of the host machine 102, such as a built-in display, touch screen, microphone, etc., or external to the housing of the host machine 102, such as a monitor connected to the host machine 102, a speaker connected to the host machine 102, etc., according to various embodiments. In some embodiments, the host machine 102 includes communication circuitry for facilitating the exchange of data, values, messages, and the like between the input/output device 205a and the components of the host machine 102. In some embodiments, the input/output device 205a includes machine-readable media for facilitating the exchange of information between the input/output device 205a and the components of the host machine 102. In still another embodiment, the input/output device 205a includes any combination of hardware components (e.g., a touchscreen), communication circuitry, and machine-readable media.

The host machine 102 includes a device identification component 207a (shown in FIG. 2A as device ID component 207a) configured to generate and/or manage a device identifier (sometimes referred to as, “mesh node ID”) associated with the host machine 102. The device identifier may include any type and form of identification used to distinguish the host machine 102 from other computing devices. In some embodiments, to preserve privacy, the device identifier may be cryptographically generated, encrypted, or otherwise obfuscated by any device and/or component of host machine 102. In some embodiments, the host machine 102 may include the device identifier in any communication (e.g., public encrypted message, private encrypted message, etc.) that the host machine 102 sends to a computing device.

The host machine 102 includes a bus (not shown), such as an address/data bus or other communication mechanism for communicating information, which interconnects the devices and/or components of host machine 102, such as processing device 202a, network interface 206a, input/output device 205a, and/or device ID component 207a.

In some embodiments, some or all the devices and/or components of host machine 102 may be implemented with the processing device 202a. For example, the host machine 102 may be implemented as a software application stored within the memory 204a and executed by the processing device 202a. Accordingly, such embodiment can be implemented with minimal or no additional hardware costs. In some embodiments, any of these above-recited devices and/or components rely on dedicated hardware specifically configured for performing operations of the devices and/or components.

FIG. 2B is a block diagram depicting an example environment for using a host machine including a host capacity monitoring (HCM) system, according to some embodiments. The host machine 204b (e.g., host machine 102a in FIG. 1) includes a memory 214b; and a processing device 202b that is operatively coupled to the memory. The processing device 202b is configured to receive a request 270b to analyze a performance of a containerized application 272b executing on a host machine 204b, the containerized application 272b using one or more resources 208b of the host machine 204b to provide a quality of service 232b. The processing device 202b is configured to acquire performance data 242b associated with the containerized application 272b by applying one or more stresses 218b to the one or more resources 208b. The processing device 202b is configured to determine, based on the performance data 242b, a likelihood for a degradation in the quality of service 232b occurring prior to a satisfaction of one or more rules 275b associated with a remedial action 292b. The processing device 202b is configured to perform, prior to the satisfaction of the one or more rules 275b, the remedial action 292b to prevent the degradation in the quality of service 232b.

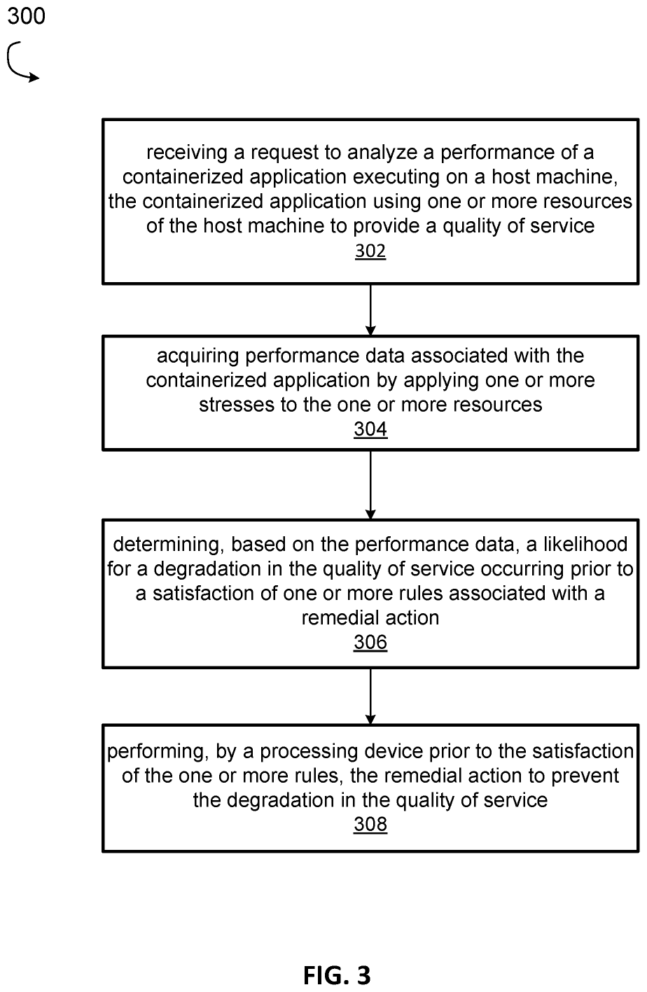

FIG. 3 is a flow diagram depicting a method of proactive hosting capacity analysis and evaluation for dynamic container migration, according to some embodiments. Method 300 may be performed by processing logic that may include hardware (e.g., circuitry, dedicated logic, programmable logic, a processor, a processing device, a central processing unit (CPU), a system-on-chip (SoC), etc.), software (e.g., instructions and/or an application that is running/executing on a processing device), firmware (e.g., microcode), or a combination thereof. In some embodiments, method 300 may be performed by a host machine, such as host machine 102a in FIG. 1.

With reference to FIG. 3, method 300 illustrates example functions used by various embodiments. Although specific function blocks (“blocks”) are disclosed in method 300, such blocks are examples. That is, embodiments are well suited to performing various other blocks or variations of the blocks recited in method 300. It is appreciated that the blocks in method 300 may be performed in an order different than presented, and that not all of the blocks in method 300 may be performed.

As shown in FIG. 3, the method 300 includes the block 302 of receiving a request to analyze a performance of a containerized application executing on a host machine, the containerized application using one or more resources of the host machine to provide a quality of service. The method 300 includes the block 304 of acquiring performance data associated with the containerized application by applying one or more stresses to the one or more resources. The method 400 includes the block 306 of determining, based on the performance data, a likelihood for a degradation in the quality of service occurring prior to a satisfaction of one or more rules associated with a remedial action. The method 300 includes the block 308 of performing, by a processing device prior to the satisfaction of the one or more rules, the remedial action to prevent the degradation in the quality of service.

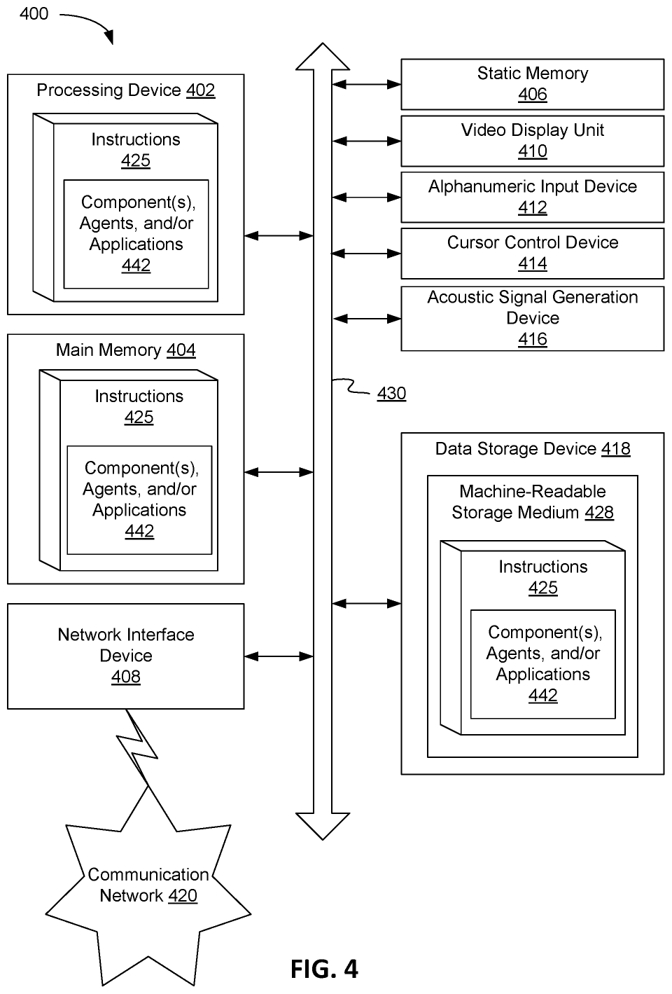

FIG. 4 is a block diagram of an example computing device 400 that may perform one or more of the operations described herein, in accordance with some embodiments. Computing device 400 may be connected to other computing devices in a LAN, an intranet, an extranet, and/or the Internet. The computing device may operate in the capacity of a server machine in client-server network environment or in the capacity of a client in a peer-to-peer network environment. The computing device may be provided by a personal computer (PC), a set-top box (STB), a server, a network router, switch or bridge, or any machine capable of executing a set of instructions (sequential or otherwise) that specify actions to be taken by that machine. Further, while only a single computing device is illustrated, the term “computing device” shall also be taken to include any collection of computing devices that individually or jointly execute a set (or multiple sets) of instructions to perform the methods discussed herein.

The example computing device 400 may include a processing device (e.g., a general-purpose processor, a PLD, etc.) 402, a main memory 404 (e.g., synchronous dynamic random-access memory (DRAM), read-only memory (ROM)), a static memory 406 (e.g., flash memory and a data storage device 418), which may communicate with each other via a bus 430.

Processing device 402 may be provided by one or more general-purpose processing devices such as a microprocessor, central processing unit, or the like. In an illustrative example, processing device 402 may include a complex instruction set computing (CISC) microprocessor, reduced instruction set computing (RISC) microprocessor, very long instruction word (VLIW) microprocessor, or a processor implementing other instruction sets or processors implementing a combination of instruction sets. Processing device 402 may also include one or more special-purpose processing devices such as an application specific integrated circuit (ASIC), a field programmable gate array (FPGA), a digital signal processor (DSP), network processor, or the like. The processing device 402 may be configured to execute the operations described herein, in accordance with one or more aspects of the present disclosure, for performing the operations and steps discussed herein.

Computing device 400 may further include a network interface device 408 which may communicate with a communication network 420. The computing device 400 also may include a video display unit 410 (e.g., a liquid crystal display (LCD) or a cathode ray tube (CRT)), an alphanumeric input device 412 (e.g., a keyboard), a cursor control device 414 (e.g., a mouse) and an acoustic signal generation device 416 (e.g., a speaker). In one embodiment, video display unit 410, alphanumeric input device 412, and cursor control device 414 may be combined into a single component or device (e.g., an LCD touch screen).

Data storage device 418 may include a computer-readable storage medium 428 on which may be stored one or more sets of instructions 425 that may include instructions for one or more components, agents, and/or applications 442 (e.g., probe request agent 107, probe platform 109, host monitor agent 105, CCM agent 106 in FIG. 1) for carrying out the operations described herein, in accordance with one or more aspects of the present disclosure. Instructions 425 may also reside, completely or at least partially, within main memory 404 and/or within processing device 402 during execution thereof by computing device 400, main memory 404 and processing device 402 also constituting computer-readable media. The instructions 425 may further be transmitted or received over a communication network 420 via network interface device 408.

While computer-readable storage medium 428 is shown in an illustrative example to be a single medium, the term “computer-readable storage medium” should be taken to include a single medium or multiple media (e.g., a centralized or distributed database and/or associated caches and servers) that store the one or more sets of instructions. The term “computer-readable storage medium” shall also be taken to include any medium that is capable of storing, encoding or carrying a set of instructions for execution by the machine and that cause the machine to perform the methods described herein. The term “computer-readable storage medium” shall accordingly be taken to include, but not be limited to, solid-state memories, optical media and magnetic media.

Unless specifically stated otherwise, terms such as “receiving” “acquiring,” “determining,” “performing,” “deploying,” “applying,” “detecting,” “maintaining,” “causing,” or the like, refer to actions and processes performed or implemented by computing devices that manipulates and transforms data represented as physical (electronic) quantities within the computing device's registers and memories into other data similarly represented as physical quantities within the computing device memories or registers or other such information storage, transmission or display devices. Also, the terms “first,” “second,” “third,” “fourth,” etc., as used herein are meant as labels to distinguish among different elements and may not necessarily have an ordinal meaning according to their numerical designation.

Examples described herein also relate to an apparatus for performing the operations described herein. This apparatus may be specially constructed for the required purposes, or it may include a general-purpose computing device selectively programmed by a computer program stored in the computing device. Such a computer program may be stored in a computer-readable non-transitory storage medium.

The methods and illustrative examples described herein are not inherently related to any particular computer or other apparatus. Various general-purpose systems may be used in accordance with the teachings described herein, or it may prove convenient to construct more specialized apparatus to perform the required method steps. The required structure for a variety of these systems will appear as set forth in the description above.

The above description is intended to be illustrative, and not restrictive. Although the present disclosure has been described with references to specific illustrative examples, it will be recognized that the present disclosure is not limited to the examples described. The scope of the disclosure should be determined with reference to the following claims, along with the full scope of equivalents to which the claims are entitled.

As used herein, the singular forms “a”, “an” and “the” are intended to include the plural forms as well, unless the context clearly indicates otherwise. It will be further understood that the terms “comprises”, “comprising”, “includes”, and/or “including”, when used herein, specify the presence of stated features, integers, steps, operations, elements, and/or components, but do not preclude the presence or addition of one or more other features, integers, steps, operations, elements, components, and/or groups thereof. Therefore, the terminology used herein is for the purpose of describing particular embodiments only and is not intended to be limiting.

It should also be noted that in some alternative implementations, the functions/acts noted may occur out of the order noted in the figures. For example, two figures shown in succession may in fact be executed substantially concurrently or may sometimes be executed in the reverse order, depending upon the functionality/acts involved.

Although the method operations were described in a specific order, it should be understood that other operations may be performed in between described operations, described operations may be adjusted so that they occur at slightly different times or the described operations may be distributed in a system which allows the occurrence of the processing operations at various intervals associated with the processing.

Various units, circuits, or other components may be described or claimed as “configured to” or “configurable to” perform a task or tasks. In such contexts, the phrase “configured to” or “configurable to” is used to connote structure by indicating that the units/circuits/components include structure (e.g., circuitry) that performs the task or tasks during operation. As such, the unit/circuit/component can be said to be configured to perform the task, or configurable to perform the task, even when the specified unit/circuit/component is not currently operational (e.g., is not on). The units/circuits/components used with the “configured to” or “configurable to” language include hardware—for example, circuits, memory storing program instructions executable to implement the operation, etc. Reciting that a unit/circuit/component is “configured to” perform one or more tasks, or is “configurable to” perform one or more tasks, is expressly intended not to invoke 35 U.S.C. § 112, sixth paragraph, for that unit/circuit/component. Additionally, “configured to” or “configurable to” can include generic structure (e.g., generic circuitry) that is manipulated by software and/or firmware (e.g., an FPGA or a general-purpose processor executing software) to operate in manner that is capable of performing the task(s) at issue. “Configured to” may also include adapting a manufacturing process (e.g., a semiconductor fabrication facility) to fabricate devices (e.g., integrated circuits) that are adapted to implement or perform one or more tasks. “Configurable to” is expressly intended not to apply to blank media, an unprogrammed processor or unprogrammed generic computer, or an unprogrammed programmable logic device, programmable gate array, or other unprogrammed device, unless accompanied by programmed media that confers the ability to the unprogrammed device to be configured to perform the disclosed function(s).

The foregoing description, for the purpose of explanation, has been described with reference to specific embodiments. However, the illustrative discussions above are not intended to be exhaustive or to limit the present disclosure to the precise forms disclosed. Many modifications and variations are possible in view of the above teachings. The embodiments were chosen and described to best explain the principles of the embodiments and its practical applications, to thereby enable others skilled in the art to best utilize the embodiments and various modifications as may be suited to the particular use contemplated. Accordingly, the present embodiments are to be considered as illustrative and not restrictive, and the present disclosure is not to be limited to the details given herein, but may be modified within the scope and equivalents of the appended claims.

What is claimed is:

1. A method, comprising:
receiving a request to analyze a performance of a containerized application executing on a host machine, the containerized application using one or more resources of the host machine to provide a quality of service;
acquiring performance data associated with the containerized application by applying one or more stresses to the one or more resources;
determining, based on the performance data, a likelihood for a degradation in the quality of service occurring prior to a satisfaction of one or more rules associated with a remedial action; and
performing, by a processing device prior to the satisfaction of the one or more rules, the remedial action to prevent the degradation in the quality of service.

2. The method of claim 1, wherein the request comprises mapping data indicating one or more probes, and further comprising:
deploying the one or more probes onto the host machine to monitor the one or more resources.

3. The method of claim 2, wherein applying the one or more stresses to the one or more resources is further based on the one or more probes.

4. The method of claim 1, wherein the performance data is indicative of at least one of a current demand on the one or more resources or a remaining capacity of the one or more resources.

5. The method of claim 1, further comprising:
detecting a change in the quality of service responsive to applying the one or more stresses to the one or more resources.

6. The method of claim 1, further comprising:
maintaining, in a data store, a plurality of associations between a plurality of containerized application identifiers and a plurality of probe identifiers.

7. The method of claim 1, wherein performing the remedial action comprises at least one of:
causing a migration of the containerized application from the host machine to another host machine, or
preventing a migration of another containerized application from another host machine to the host machine.

8. The method of claim 1, wherein performing the remedial action comprises:
providing a notification indicating a likelihood for a degradation in the quality of service occurring prior to a satisfaction of one or more rules associated with a remedial action.

9. The method of claim 1, wherein determining the likelihood for the degradation in the quality of service occurring prior to the satisfaction of the one or more rules associated with the remedial action is further based on environmental conditions associated with the host machine.

10. The method of claim 9, wherein the environmental conditions comprise one or more of temperature, electromagnetic interference, pressure, or humidity.

11. A system, comprising:
a memory; and
a processing device, operatively coupled to the memory, to:
receive a request to analyze a performance of a containerized application executing on a host machine, the containerized application using one or more resources of the host machine to provide a quality of service;
acquire performance data associated with the containerized application by applying one or more stresses to the one or more resources;
determine, based on the performance data, a likelihood for a degradation in the quality of service occurring prior to a satisfaction of one or more rules associated with a remedial action; and
perform, prior to the satisfaction of the one or more rules, the remedial action to prevent the degradation in the quality of service.

12. The system of claim 11, wherein the request comprises mapping data indicating one or more probes, and wherein the processing device is to:
deploy the one or more probes onto the host machine to monitor the one or more resources.

13. The system of claim 12, wherein to apply the one or more stresses to the one or more resources is further based on the one or more probes.

14. The system of claim 11, wherein the performance data is indicative of at least one of a current demand on the one or more resources or a remaining capacity of the one or more resources.

15. The system of claim 11, wherein the processing device is to:
detect a change in the quality of service responsive to applying the one or more stresses to the one or more resources.

16. The system of claim 11, wherein the processing device is to:
maintain, in a data store, a plurality of associations between a plurality of containerized application identifiers and a plurality of probe identifiers.

17. The system of claim 11, wherein to perform the remedial action, the processing device is to at least one of:
cause a migration of the containerized application from the host machine to another host machine, or
prevent a migration of another containerized application from another host machine to the host machine.

18. The system of claim 11, wherein to perform the remedial action, the processing device is to:
provide a notification indicating a likelihood for a degradation in the quality of service occurring prior to a satisfaction of one or more rules associated with a remedial action.

19. The system of claim 11, wherein to determine the likelihood for the degradation in the quality of service occurring prior to the satisfaction of the one or more rules associated with the remedial action is further based on environmental conditions associated with the host machine, wherein the environmental conditions comprise one or more of temperature, electromagnetic interference, pressure, or humidity.

20. A non-transitory computer-readable medium storing instructions that, when execute by a processing device, cause the processing device to:
receive a request to analyze a performance of a containerized application executing on a host machine, the containerized application using one or more resources of the host machine to provide a quality of service;
acquire performance data associated with the containerized application by applying one or more stresses to the one or more resources;
determine, based on the performance data, a likelihood for a degradation in the quality of service occurring prior to a satisfaction of one or more rules associated with a remedial action; and
perform, by the processing device prior to the satisfaction of the one or more rules, the remedial action to prevent the degradation in the quality of service.
